(19) United States
(12) Patent Application Publication
(10) Pub. No.: US 2022/0092612 A1
(43) Pub. Date: Mar. 24, 2022

(54) SYSTEM AND METHOD FOR AUTOMATICALLY DETECTING ANOMALY PRESENT WITHIN DATASET(S)

(71) Applicant: Larsen & Toubro Infotech Ltd, Mumbai (IN)

(72) Inventors: S. Bharath, Madurai (IN); Navneet Hari, Tellicherry Kannur (IN); Akshit Sharma, Chandigarh (IN); Vishnu Vardhanan Mohanraj, Bengaluru (IN)

(73) Assignee: Larsen & Toubro Infotech Ltd, Mumbai (IN)

(21) Appl. No.: 17/206,111

(22) Filed: Mar. 18, 2021

(30) Foreign Application Priority Data
Sep. 21, 2020 (IN) 202021040779

(51) Int. Cl. G06Q 30/02

(52) U.S. Cl. CPC G06Q 30/0201

(57) ABSTRACT

A method and a system for automatically detecting anomalies present within a dataset is provided. An embodiment performs analysis on detected anomalies to calculate severity and detects root cause of the anomalies. The dataset may contain sales, revenue, and profit data. The anomalies are detected may include a historical data deviation anomaly, a latest data deviation anomaly, a data add anomaly, or a data loss anomaly. Severity of the detected anomalies is calculated by a severity calculation scheme. The severity calculation uses several parameters in calculating the severity rank of the anomalies. A root cause of the detected anomalies is identified by lookup to detect probable reasoning behind the detected anomalies. Further, the dataset may be used to create a dashboard to visualize business insights.

### TECHNICAL FIELD OF THE DISCLOSURE

The present invention generally relates to domain of data analytics, and more particularly to a system and method for automatically detecting anomaly present within a dataset, calculating severity rank of detected anomaly and detecting root cause of the detected anomaly. The dataset comprises data related to business variables such as sales, revenue, profit, etc., further used to create a dashboard to visualize business insights comprising graphs.

### BACKGROUND

In early period of database development, a user would generally view “raw data” or data that is viewed exactly as it was entered into the database. Techniques were eventually developed to allow the data to be formatted, analyzed, and viewed in more efficient manners. This allowed, for instance, a user to apply mathematical operators to the data and even create reports. Business users could access information such as “total sales” from the data in the database that contained only individual sales. User interfaces were enhanced to further facilitate retrieving and displaying the data in an easy to understand format. Eventually users started appreciating that different views of the data, such as total sales from individual sales, allowed them to obtain additional information from the raw data in the database. This gleaning of additional data is known as “data mining” and produces “meta data” (i.e., information explaining about the data). Data mining allows valuable additional information to be extracted from the raw data. This is especially useful in business where information can be found to explain business sales and production output, beyond results solely from raw input data present in the database.

Currently, data analysis to increase data mining capabilities requires substantial user input and knowledge to ensure that erroneous data is not included in various data perspectives. This requires that the user must have intimate knowledge of the data and insight into what types of errors can occur in a dataset. Amount of stored data is generally too vast and complex for the user to efficiently develop a useable strategy to ensure that all data anomalies are uncovered.

A US patent document 7,162,489 discloses a method for automatic detection of anomalies in a dataset. The method uses a system determined value or a system determined percentage of deviation to detect the anomalies present in the dataset. The method uses a curve fitting process to detect the deviation of data values. Further, the cited prior art also discloses an algorithm to determine a deviation score for the anomalous data. The deviation score is used to calculate severity of the anomalies.

Further, a US patent document 8,661,299 discloses an anomaly detection system which receives a time-series data and compares it with a best-fit line generated by the system. The deviation of the data from the best fit line is used to detect the anomalies in a dataset. Further, cited prior art also discloses a special module which uses metric correlation with other files to determine root cause of the anomalies.

Further, a US patent application 20190236177 discloses a set of algorithms for detection of anomalies in a time-series dataset. One of the algorithms discloses a method to divide the time-series dataset into two parts and compare them to detect the anomalies. Also, in another algorithm, a percentage change of data value from previous data point value is measured and the anomalies are detected if the percentage change value is greater than a certain threshold value.

Further, a non-patent literature—A Comparative Evaluation of Unsupervised Anomaly Detection Algorithms for Multivariate Data published by “Plos one” broadly discloses a system that can detect whether a dataset is having an anomaly or not. The non-patent literature also discloses that the system can rank anomalies according to their severity and most severe anomaly will be reported to a user.

However, there doesn't exist any technique for detecting anomaly by identifying missing or added level of information in a new snapshot of data as compared to last snapshot of data and calculating severity rank of the detected anomalies by assigning weightages to the detected anomalies based on certain parameters.

Therefore, there arises a need for an automated system configured to detect the anomalies in the dataset, thereby eliminating manual error in detection of the anomalies, wherein the system is enabled to detect a missing or added level of information in the new snapshot of data compared to the last snapshot of data to detect a data add or data loss anomaly. Further, there exist a need for an advanced technique for detecting severity of the anomalies present within the dataset by assigning weightages to detected anomalies on basis of certain parameters for calculating the severity rank of each anomaly. The automated system may help a user to save a lot of time and will also increase the productivity of a process.

### SUMMARY

One or more shortcomings of prior art are overcome, and additional advantages are provided through present disclosure. Additional features are realized through techniques of the present disclosure. Other embodiments and aspects of the disclosure are described in detail herein and are considered a part of the present disclosure.

In one aspect of the disclosure, a method for detecting anomalies present within a dataset is disclosed, wherein at least one anomaly is identified within the dataset using an anomaly detection module. The anomaly detection module compares current snapshot and previous snapshot of a time series data in the dataset and flags one or more anomalous data points to identify at least one anomaly, wherein the at least one anomaly includes, a historical data deviation anomaly, a latest data deviation anomaly, a data add anomaly and a data loss anomaly. Also, a method for calculating a severity rank for detected anomalies present within the dataset is disclosed, wherein a severity rank of at least one of the anomalies is calculated using a severity calculation module, wherein the severity rank is calculated using various parameters. These parameters comprise, calculating percentage of deviation of current data values compared to previous data values, and assigning weightages to detected anomalies on basis of certain parameters related to the detected anomalies, wherein the parameters may include type of anomaly, metric of anomaly and depth of anomaly. Also, a method for root cause identification of the anomalies is disclosed which uses a lookup algorithm to detect a probable reasoning behind the detected anomalies.

In another aspect of the disclosure, a system for detecting anomalies present within a dataset is disclosed, wherein the system comprises of an anomaly detector component for identification of at least one anomaly present within a dataset. The anomaly detector component compares between current snapshot and previous snapshot of a time series data in the dataset and flags one or more anomalous data points to identify at least one anomaly, wherein the at least one anomaly includes, a historical data deviation anomaly, a latest data deviation anomaly, a data add anomaly and a data loss anomaly. Also, a system for calculating a severity rank of anomalies present within the dataset is disclosed, wherein the system comprises of a severity calculator component which calculates the severity rank by using various parameters. These parameters comprise, calculating percentage of deviation of current data values compared to previous data values, and assigning weightages to detected anomalies on basis of certain parameters related to the detected anomalies, wherein the parameters may include type of anomaly, metric of anomaly and depth of anomaly. Also, a system for detection of root cause of the anomalies is disclosed which uses a lookup algorithm to detect a probable reasoning behind the detected anomalies.

Foregoing summary is illustrative only and is not intended to be in any way limiting. In addition to illustrative aspects, embodiments, and features described above, further aspects, embodiments, and features will become apparent by reference to drawings and following detailed description.

### BRIEF DESCRIPTION OF DRAWINGS

FIG. 1 is a diagram representing a system for anomaly detection module.

FIG. 2 is a flowchart representing a method for detection of anomalies in a dataset and their analysis.

FIG. 3 is a schematic flow diagram for what analysis part of the anomaly detection module.

FIG. 4 is a schematic flow diagram for where analysis part of the anomaly detection module.

FIG. 5 is a schematic flow diagram for why analysis part of the anomaly detection module.

### DETAILED DESCRIPTION

In following detailed description of embodiments of present disclosure, numerous specific details are set forth in order to provide a thorough understanding of the embodiments of the disclosure. However, it will be obvious to one skilled in art that the embodiments of the disclosure may be practiced without these specific details. In other instances, well known methods, procedures, components, and circuits have not been described in detail so as not to unnecessarily obscure aspects of the embodiments of the disclosure.

References in the present disclosure to “one embodiment” or “an embodiment” mean that a feature, structure, characteristic, or function described in connection with the embodiment is included in at least one embodiment of the disclosure. Appearances of phrase “in one embodiment” in various places in the present disclosure are not necessarily all referring to same embodiment.

In the present disclosure, word “exemplary” is used herein to mean “serving as an example, instance, or illustration.” Any embodiment or implementation of present subject matter described herein as “exemplary” is not necessarily to be construed as preferred or advantageous over other embodiments.

The present disclosure may take form of a hardware embodiment, a software embodiment, or an embodiment combining software and hardware aspects that may all generally be referred to herein as a ‘system’ or a ‘module’. Further, the present disclosure may take form of a computer program product embodied in a storage device having computer readable program code embodied in a medium.

While the disclosure is susceptible to various modifications and alternative forms, specific embodiment thereof has been shown by way of example in drawings and will be described in detail below. It should be understood, however that it is not intended to limit the disclosure to the forms disclosed, but on contrary, the disclosure is to cover all modifications, equivalents, and alternative falling within scope of the disclosure.

Terms such as “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude existence of other elements or additional elements in the system or apparatus.

In following detailed description of the embodiments of the disclosure, reference is made to drawings that form a part hereof, and in which are shown by way of illustration specific embodiments in which the disclosure may be practiced. These embodiments are described in enough detail to enable those skilled in the art to practice the disclosure, and it is to be understood that other embodiments may be utilized and that changes may be made without departing from the scope of the present disclosure. The following description is, therefore, not to be taken in a limiting sense.

The present invention discloses a method and a system for automatically detecting anomalies present within a dataset and performing analysis on detected anomalies to calculate severity and detect root cause of the said anomalies. The dataset may comprise data related to business variables such as sales, revenue, profit, etc. The anomalies present within the dataset are detected using an anomaly detection module which uses an algorithm to detect different types of anomalies such as a historical data deviation anomaly, a latest data deviation anomaly, a data add anomaly and a data loss anomaly. Severity of the detected anomalies is calculated by using a severity calculation module which uses a severity calculation algorithm. The severity calculation algorithm uses various parameters while calculating a severity rank of the anomalies. A root cause of the detected anomalies is identified by using a root cause detection module which uses a lookup algorithm to detect a probable reasoning behind the detected anomalies. Further, the dataset may be used to create a dashboard to visualize business insights.

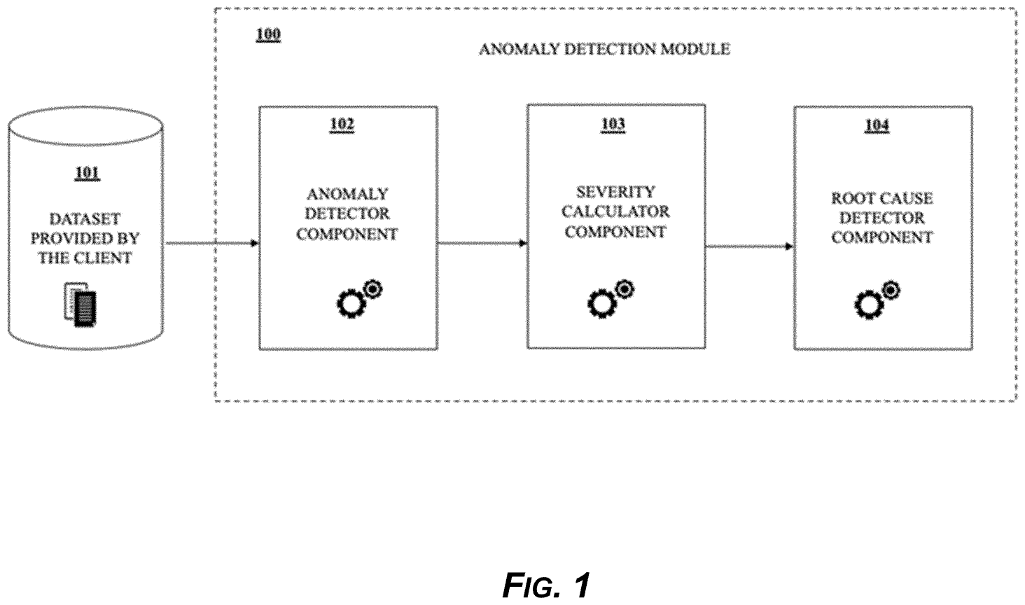

Referring to FIG. 1, a detailed view of a system for anomaly detection is disclosed, wherein a dataset 101 is provided by a client to an anomaly detection module 100. The dataset is processed by the anomaly detection module 100. The anomaly detection module comprises of one anomaly detector component 102, one severity calculator component 103 and one root cause detector component 104.

The anomaly detection component 102 detects at least one anomaly present within the dataset by using an anomaly detection algorithm. The anomaly detection algorithm compares two snapshots of time series data in the dataset to flag one or more anomalous data points present within the dataset. Types of anomalies that are detected may include a historical data deviation anomaly, a latest data deviation anomaly, a data add anomaly and a data loss anomaly.

Historical data deviation anomaly refers to a type of anomaly which is detected by comparing two snapshots of the time series data having overlapping weeks information, namely Current Snapshot (CS) and Previous Snapshot (PS).

The latest data deviation anomaly refers to a type of anomaly which is detected by taking current snapshot (CS) of a time series data which contains all values of metric till current week. It is checked if last value, which is the current week value, in the current snapshot (CS) is significantly different from the value of previous week in the current snapshot (CS).

Data add anomaly refers to a type of anomaly which is detected by taking two snapshots of a time series data, namely Current Snapshot (CS) and Previous Snapshot (PS) and checking if there is any addition of new level of information in the Current Snapshot (CS) as compared to the Previous Snapshot (PS).

Data loss anomaly refers to a type of anomaly which is detected by taking two snapshots of a time series data, namely Current Snapshot (CS) and Previous Snapshot (PS) and checking if there is any missing level of information in the Current Snapshot (CS) as compared to the Previous Snapshot (CS).

The severity calculator component 103 calculates the severity rank for at least one of the detected anomalies based on the severity calculation algorithm. The severity calculation algorithm uses various parameters while calculating the severity rank of the anomalies. These parameters may include, calculating percentage of deviation of current data values compared to previous data values, and assigning weightages to the detected anomalies on basis of certain parameters related to the detected anomalies, wherein the parameters may include type of anomaly, metric of anomaly and depth of anomaly.

The percentage delta change refers to a numeric factor which is taken into consideration while calculating the severity rank of the anomalies. It explains amount of change that has been seen in the metric which was flagged as an anomaly. The numeric factor can have values between −100% to +infinity %.

The type of anomaly is second factor which is taken into consideration while calculating the severity rank of the anomalies. There can be n different types of anomalies present in the dataset and the type of anomaly factor is used to give more importance to one type of anomaly over another type of anomaly. The four types of anomalies present in the dataset which are taken into consideration are historical data deviation anomaly, latest data deviation anomaly, data add anomaly and data loss anomaly. Different weights are assigned to the four types of anomalies types of anomalies to calculate the severity rank of the anomalies.

The type of metric is another factor which is taken into consideration while calculating the severity rank of the anomalies. There can be different types anomalies present for different metrics in a single dataset. These metrics can be sales, profit, revenue, volume, compound annual growth, etc. The type of metric factor is used to give more weightage to one metric over another in terms of severity.

The depth of anomaly is another factor which is taken into consideration while calculating the severity rank of the anomalies. There can be multiple dimension levels present in the dataset with some hierarchy. For example, if there is a geographical hierarchy of dimensions—Zone, State, City, Area present in the dataset then more importance should be given to any anomaly which is being triggered at a Zone level as compared to one at an Area level. Therefore, for such scenarios the depth of anomaly factor plays a crucial role in deciding the severity rank of the anomalies as different weights are given to different anomalies of different depth.

There are two ways by which different weights can be given to the different anomalies i.e. giving pre-configured weights to the anomalies or giving user-defined weights to the anomalies. Pre-configured weights are assigned by the system on basis of business understanding. The pre-configured weights are combined on fly for each of the anomalies to get a final severity index. On other hand, the user-defined weights are assigned on basis of user's choice. For assigning the user defined weights, a user/data steward can pick and choose any or all the four parameters that affect severity ranking and assign some relevant weights to them which will then be used to calculate the final severity index for all the anomalies.

The root cause detector component 104 is used for detecting a probable reasoning behind one of the detected anomalies by using the lookup algorithm. The root cause detector component prefers input from the anomaly detector component.

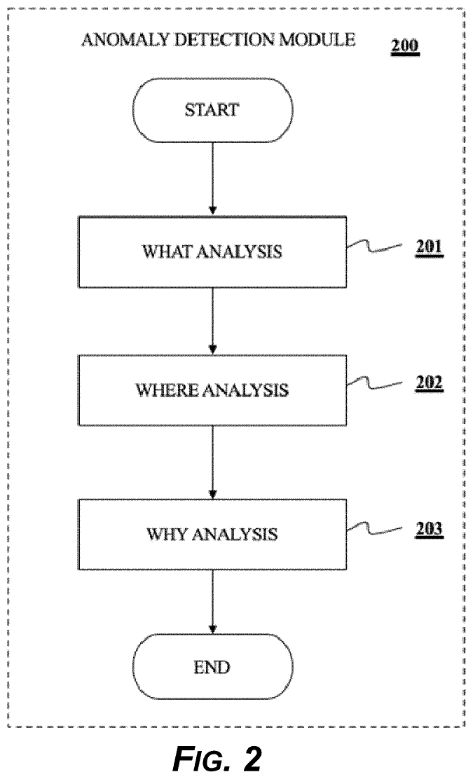

Referring to FIG. 2, a flowchart for method of detecting and analyzing anomalies is disclosed by using an anomaly detection module 200, comprising three different steps to detect and analyze the anomalies, wherein each of the step comprise a separate set of algorithms for execution. The three steps are namely, “what analysis” 201, “where analysis” 202 and “why analysis” 203. Here, the “what analysis” step 201 is processed by the anomaly detector component, as mentioned in FIG. 1, the “where analysis” step 202 is processed by the severity calculation component, as mentioned in FIG. 1, and the “Why analysis” part 203 is processed by the root cause detector component, as mentioned in FIG. 1.

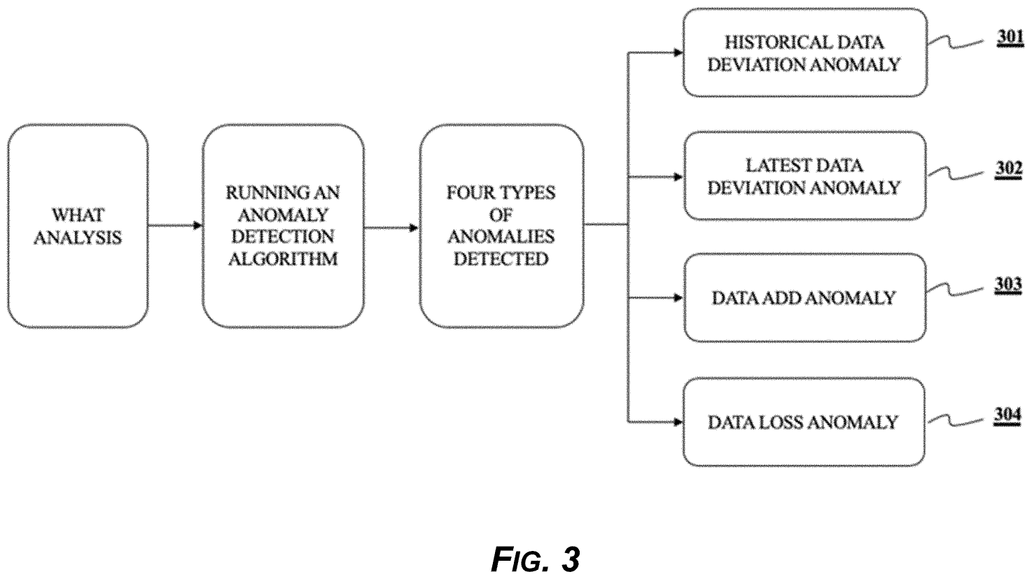

FIG. 3 provides schematic flow diagram for the “What analysis” part of the anomaly detection module. The “What analysis” refers to algorithms used for detecting different types of anomalies present within the dataset by using the anomaly detection module. The algorithms compare two snapshots of time series data to flag any anomalous data points using statistical methods. There are four types of anomalies that can be detected using the anomaly detection algorithm i.e. historical data deviation anomaly 301, latest data deviation anomaly 302, data add anomaly 303 and data loss anomaly 304.

Historical data deviation 301 anomaly refers to a type of anomaly which is detected by comparing two snapshots of the time series data having overlapping weeks information, namely Current Snapshot (CS) and Previous Snapshot (PS). It is checked if values in Current Snapshot (CS) are significantly different from Previous Snapshot (PS). For picking out an anomaly, covariance (COV) of two series is found. With help of covariance (COV) and setting up a confidence interval (CI), a dynamic Upper Control Limit (UCL) and a Lower Control Limit (LCL) is created overlaying on top of the Current Snapshot (CS) using the Previous Snapshot (PS).

Formulae used for calculating the UCL and the LCL are:

UCL=PS+CI*square-root(COV)

LCL=PS−CI*square-root(COV)

Where CI=1.96 (for 95% confidence interval)

For any values in the Current Snapshot (CS), which goes above the UCL or below the LCL is marked as historical data deviation anomaly.

The latest data deviation 302 anomaly refers to a type of anomaly which is detected by taking current snapshot (CS) of a time series data which contains all values of metric till current week. It is checked if last value, which is the current week value, in the current snapshot (CS) is significantly different from the value of previous week in the current snapshot (CS). For picking out the anomaly, simple moving average (MA) of the series with a set interval (I) is calculated. A dynamic Upper Control Limit (UCL) and a Lower Control Limit (LCL) is created by adding and subtracting product of confidence interval (CI) standard error (SE) from the MA value of the previous week respectively.

Formulae used for calculating UCL and LCL are:

CL(n)=MA(n)+CI*SE

LCL(n)=MA(n)−CI*SE

Where n=current week,

n−1=previous week,

SE=Standard Deviation of Sample/square-root(I)\

CI=1.96 (for 95% confidence interval)

If actual value of current week goes above the UCL or below the LCL then latest week value is marked as latest data deviation anomaly.

Data add anomaly 303 refers to a type of anomaly which is detected by taking two snapshots of a time series data, namely Current Snapshot (CS) and Previous Snapshot (PS) and checking if there is any addition of new level of information in the Current Snapshot (CS) as compared to the Previous Snapshot (PS). For picking out the anomaly, unique set of levels present in the Current Snapshot (CS) and the Previous Snapshot (PS) are found separately for an entire period. Levels from both snapshots are compared by applying relevant join operations. For any level which was not present in the Previous Snapshot (CS) but came up in the Current Snapshot (CS), level is flagged as data add anomaly and an extra value of metric is showcased which this new level is adding up in the Current Snapshot (CS)

Data loss anomaly 304 refers to a type of anomaly which is detected by taking two snapshots of a time series data, namely Current Snapshot (CS) and Previous Snapshot (PS) and checking if there is any missing level of information in the Current Snapshot (CS) as compared to the Previous Snapshot (CS). For picking out the anomaly, unique set of levels present in the Current Snapshot (CS) and the Previous Snapshot (CS) is found separately for an entire period. The levels from both snapshots are compared by applying relevant join operations. For any level which was present in the Previous Snapshot (CS) but went missing in the Current Snapshot (CS), that level is flagged as the data loss anomaly and a value of metric is showcased which went missing because of it in the Current Snapshot (CS).

After flagging all four types of anomalies present within the dataset, a second step is executed by a severity detection module which is known as the “Where analysis”.

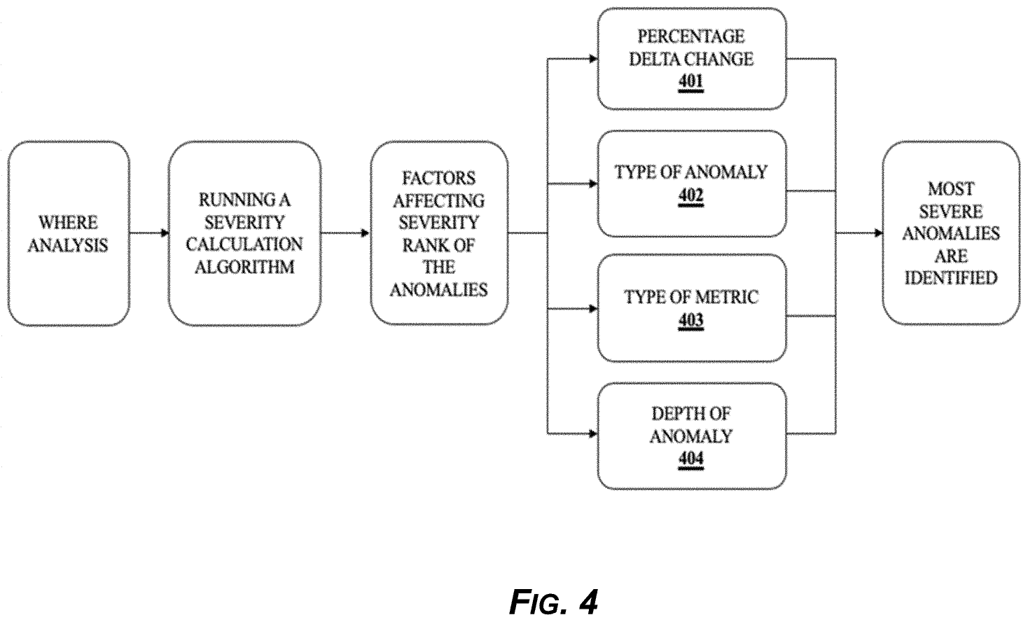

FIG. 4 explains the schematic flow diagram for the “Where analysis” part of anomaly detection module. The “Where analysis” refers to a technique used to check the severity of each anomaly present in the dataset. The severity calculation algorithm is used to rank the anomalies according to their severity and most severe anomalies are identified. A deep dive analysis is done to pick up a focus area of the most severe anomalies.

The severity calculation algorithm takes in four parameters into consideration which are a blend of logical and business inputs to assign the severity rank for any given anomaly. The four parameters taken in consideration are percentage delta change 401, type of anomaly 402, type of metric 403 and depth of anomaly 404.

The percentage delta change 401 refers to a numeric factor which is taken into consideration while calculating the severity rank of the anomalies. It explains amount of change that has been seen in the metric which was flagged as an anomaly. The numeric factor can have values between −100% to +infinity %.

The type of anomaly 402 is second factor which is taken into consideration while calculating the severity rank of the anomalies. There can be n different types of anomalies present in the dataset and the type of anomaly factor is used to give more importance to one type of anomaly over another type of anomaly. The four types of anomalies present in the dataset which are taken into consideration are historical data deviation anomaly, latest data deviation anomaly, data add anomaly and data loss anomaly. Different weights are assigned to the four types of anomalies types of anomalies to calculate the severity rank of the anomalies.

The type of metric 403 is another factor which is taken into consideration while calculating the severity rank of the anomalies. There can be different types anomalies present for different metrics in a single dataset. These metrics can be sales, profit, revenue, volume, compound annual growth, etc. The type of metric factor is used to give more weightage to one metric over another in terms of severity.

The depth of anomaly 404 is another factor which is taken into consideration while calculating the severity rank of the anomalies. There can be multiple dimension levels present in the dataset with some hierarchy. For example, if there is a geographical hierarchy of dimensions—Zone, State, City, Area present in the dataset then more importance should be given to any anomaly which is being triggered at a Zone level as compared to one at an Area level. Therefore, for such scenarios the depth of anomaly factor plays a crucial role in deciding the severity rank of the anomalies as different weights are given to different anomalies of different depth.

There are two ways by which different weights can be given to the different anomalies i.e. giving pre-configured weights to the anomalies or giving user-defined weights to the anomalies. Pre-configured weights are assigned by the system on basis of business understanding. The pre-configured weights are combined on fly for each of the anomalies to get a final severity index. On other hand, the user-defined weights are assigned on basis of user's choice. For assigning the user defined weights, a user/data steward can pick and choose any or all the four parameters that affect severity ranking and assign some relevant weights to them which will then be used to calculate the final severity index for all the anomalies.

After severity analysis of all the anomalies present within the dataset by considering all the four parameters, a severity rank is provided to each of the detected anomalies and the most severe anomalies are identified.

The third step is executed by a root cause detector module, which is known as the “Why analysis”.

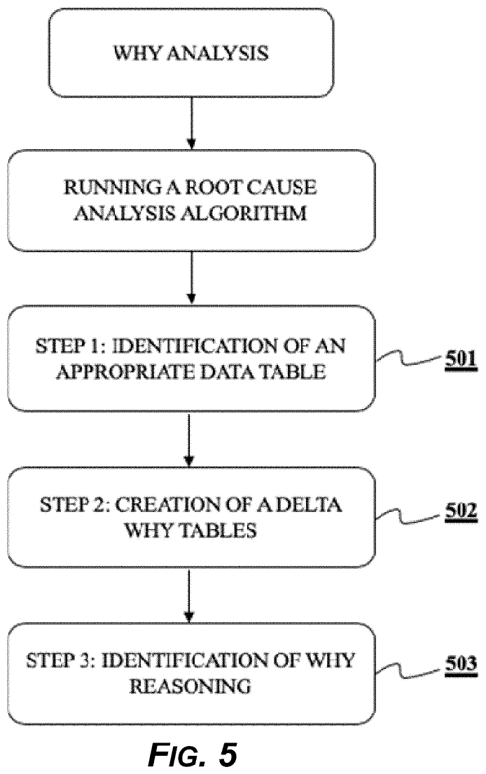

FIG. 5 provides schematic flow diagram for the “why analysis” part of the anomaly detection module. The “why analysis” refers to a technique used to identify probable root cause or reasoning behind the anomalies. The “why analysis” part plays a diagnostic role in the Anomaly Detection module for answering the question “WHY has the anomaly occurred?”. This can be achieved with help of supplementary datasets (Why tables) which act as fact tables for the dataset used for the Anomaly detection module. These fact tables will list out attributes for level (say L1) at which anomaly (say A1) was generated in a main module. WHY reasoning analysis can be broken down into three steps i.e. identification of appropriate data table 501, creation of delta why tables 502, and identification of why reasoning 503.

The identification of the appropriate data table 501 is first step for why reasoning analysis of the anomalies. For identifying the probable cause for understanding why the anomaly has occurred, a specific dataset is required to answer the cause. For example, in order to identify why sales has shown a significant drop in a particular territory across sales snapshots, a fact table is needed which contains territory-wise breakup of sales at say store level and the fact table for two snapshots is compared, stores for that territory which witnessed a change/slump in sales are identified and contributed to sales drop in that territory. In order to answer the Why reasoning under different lenses (say for e.g. across geographical, customer, product categories), the fact tables for the same are maintained.

The creation of delta why tables 502 is second step for why reasoning analysis of the anomalies. Since it is of an interest to identify those levels in why fact tables which have shown change across snapshots and hence have contributed to the anomaly, only those records of the Why tables are kept which have exhibited change across snapshots. For e.g. if there are two snapshots (current and previous) of particular Why table, only records of levels are kept which have shown a change in their attributes (for e.g. change in their sales allocation, sales volume) across snapshots, dropping those levels whose attributes haven't changed across snapshots and hence not contributed to the change (data deduplication). This process generates a delta why table for a snapshot pair of the why table.

The identification of the Why reasoning 503 is third step for why reasoning analysis of the anomalies. When presented with the anomaly A1, the level L1 of the anomaly is identified and checked whether the L1 has a corresponding entry in the set of delta Why tables. Impact of change of the L1 is quantified in different delta Why tables and those attribute changes are checked which have impacted most for measure. This helps to identify the most probable reason for anomalous behavior of the L1 across the snapshots of the main data.

We claim:

1. A method for detecting anomalies present within a dataset, the method comprising:
identifying at least one anomaly present within the dataset using an anomaly detection module, wherein the anomaly detection module performs comparison between current snapshot and previous snapshot of a time series data in the dataset and flags one or more anomalous data points to identify at least one anomaly, wherein the at least one anomaly includes, but not limited to, a data add anomaly and a data loss anomaly;
wherein said data add anomaly is identified by comparing level of information present in the current snapshot to the level of information present in the previous snapshot and then flagging a data add anomaly if there is an addition of at least one level of information in current snapshot as compared to previous snapshot; and
wherein said data loss anomaly is identified by comparing level of information present in the current snapshot to the level of information present in the previous snapshot and then flagging a data loss anomaly if there is a loss of at least one level of information in current snapshot as compared to previous snapshot.

2. A method for calculating a severity rank of anomalies present within a dataset, the method comprising:
calculating a severity rank of at least one of the anomalies using a severity calculation module;
assigning a weightage to at least one of the anomalies by the severity calculation module, wherein the severity calculation module calculates the severity rank on the basis of one or more pre-defined parameters; and
wherein the parameters are based on type of the anomalies, metric of the anomalies and depth of the anomalies.

3. The method as claimed in claim 2, wherein the weightage provided to the anomalies comprises a pre-configured weightage.

4. The method as claimed in claim 2, wherein the weightage provided to the anomalies comprises a user-defined weightage.

5. The method as claimed in claim 2, wherein the parameter for the type of the anomalies refers to the type of anomaly present within the dataset which includes, but is not limited to, a historical data deviation anomaly, a latest data deviation anomaly, a data add anomaly, and a data loss anomaly.

6. The method as claimed in claim 2, wherein the parameter for the depth of the anomalies refers to a hierarchal level of the anomalous data, wherein the hierarchal level includes, but is not limited to, a zone, a city, a state, or an area.

7. The method as claimed in claim 2, wherein the parameter for the metric of the anomalies refers to the metric of the anomalies present within the dataset which includes, but is not limited to, sales, revenue, profit, volume, or compound annual growth.

8. The method as claimed in claim 1, wherein a root cause of at least one of the identified anomalies is detected by using a root cause detection module.

9. A system for detecting anomalies present within a dataset, the system comprising:
an anomaly detector component for identification of at least one anomaly present within a dataset, wherein the anomaly detector component performs comparison between a current snapshot and a previous snapshot of a time series data in the dataset and flags one or more anomalous data points to identify at least one anomaly, wherein the at least one anomaly includes, but is not limited to, a data add anomaly and a data loss anomaly;
wherein said data add anomaly is identified by comparing level of information present in the current snapshot to the level of information present in the previous snapshot and then flagging a data add anomaly if there is an addition of at least one level of information in current snapshot as compared to previous snapshot; and
wherein said data loss anomaly is identified by comparing a level of information present in the current snapshot to the level of information present in the previous snapshot and then flagging a data loss anomaly when there is a loss of at least one level of information in the current snapshot as compared to the previous snapshot.

10. A system for calculating a severity rank of anomalies present within a dataset, the system comprising:
a severity calculator component, wherein the severity calculator component calculates the severity rank by assigning a weightage to at least one of the anomalies on the basis of pre-defined parameters, wherein the pre-defined parameters are based on a type of the anomalies, a metric of the anomalies and a depth of the anomalies.

11. The system as claimed in claim 10, wherein the weightage assigned to the anomalies comprises a pre-configured weightage.

12. The system as claimed in claim 10, wherein the weightage assigned to the anomalies comprises a user-defined weightage.

13. The system as claimed in claim 10, wherein the parameter for the type of the anomalies refers to the type of anomaly present within the dataset which includes, but is not limited to, a historical data deviation anomaly, a latest data deviation anomaly, a data add anomaly, or a data loss anomaly.

14. The system as claimed in claim 10, wherein the parameter for the depth of the anomalies refers to a hierarchal level of the anomalous data, wherein the hierarchal level includes, but is not limited to, a zone, a city, a state, or an area.

15. The system as claimed in claim 10, wherein the parameter for the metric of the anomalies refers to the metric of the anomalies present within the dataset which includes, but is not limited to, sales, revenue, profit, volume, or compound annual growth.

16. The system as claimed in claim 9, wherein a root cause of at least one of the identified anomalies is detected using a root cause detector component.
